(19) United States
(12) Patent Application Publication
(10) Pub. No.: US 2005/0200184 A1
(43) Pub. Date: Sep. 15, 2005

(54) Mechanically locked recliners

(75) Inventors: Ronald R. Siegrist, Grass Lake, MI (US); Robert J. Hicks, Canton, MI (US); Minal Mulay, Farmington Hills, MI (US); Roger L. Meyerink, South Lyon, MI (US); Anthony M. Kestian, Highland, MI (US); James Dostine, Canton, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 11/062,535

(22) Filed: Feb. 22, 2005

Related U.S. Application Data
(60) Provisional application No. 60/547,524, filed on Feb. 25, 2004.

(51) Int. Cl. B60N 2/20

(52) U.S. Cl. 297/374; 297/354.12

(57) ABSTRACT

Problems resulting from weld failures in the assembly of vehicle seats are reduced by providing a mechanical lock between a seat frame component and a recliner component. Because impact or impulse forced movement of the components is limited by the mechanical lock, reliance on welding alone is eliminated and the amount of welding done during assembly is reduced. The combined seat and recliner components can accordingly be assembled at reduced cost, and increased torsion moment in the side member resulting from the mechanical lock can further result in the mass (weight) of the system being reduced.

### CROSS-REFERENCE TO RELATED PATENT APPLICATIONS

This application is an application claiming the benefit under 35 U.S.C. § 119(e) U.S. Application Ser. No. 60/547,524, filed Feb. 25, 2004, incorporated herein by reference in its entirety.

### FIELD OF THE INVENTION

The present invention relates generally to the art of vehicle seating, and more particularly to the assembly of recliner components to frame elements of the seats. In its most preferred form, the present invention relates to mechanically locking certain recliner components to seat frame side members to reduce problems inherent in current designs, to reduce assembly time, and in some instances, to reduce the seat weight by reducing the mass of the side members.

### BACKGROUND

It is known in the art that a tilt-back recliner seat for a vehicle can be prepared by welding a component of the recliner to a component of the seat. For example, it is known that a recliner plate can be coupled to an exterior facing surface of a seat side member, typically by the use of welding or of fasteners. Several of such processes will be described below.

Ensuring that the attachment of the above-referenced components will not fail during use is very important, especially in impact or impulse situations where substantial stress can be applied. Accordingly, the welding or fastening must be tested, and the number of attachment points may be increased to provide a margin of error. Failures of the attachment system can result in injury to seat occupants and/or costly repairs of the overall seat systems. It would therefore be highly desirable to find a different way to couple such components to enhance safety weight and reduce assembly time, or costs.

Techniques for combining recliner plates with seat side members are shown in U.S. Pat. No. 6,398,300 issued Jun. 4, 2002 to Young for “Seat Backrest Mounting.” In this device, a load dispersing member is clamped into a complementary recess in the seat frame as threaded fasteners are rotated for assembly. Sides of the load dispersing members are urged into contact with the edges of the recesses. In one embodiment, the load dispersing member is formed as part of a recliner plate. As with other known systems, the recliner plate is coupled to an exterior surface of the seat frame.

Another structure for a Vehicle Seat Element and a Method of Making Such a Structure” is shown and described in U.S. Published Application No. U.S. 2003/0117003 A1, published Jun. 26, 2003, with Fourrey et al. as inventors. In this document, the main new feature is that the regular seat frame is prepared from a thermoplastic matrix and reinforcing fibers. Recliner fixing portions are attached to the structure, and a hinge is included to permit rotation of one fixing portion relative to another, or the locking thereof. A cross-member is formed at the lower end of the structure sideplates, and the hinge is overmolded by a first end of a first side plate.

A connection between a recliner plate and a seat element is also shown in U.S. Pat. No. 6,572,196 issued Jun. 3, 2003 to Thieme et al. for “Structural Part Connection Between Two Structural Parts of a Car Seat.” The parts are coupled to each other by both welding and by a positive mechanical lock. In this instance, the latter is created by a projecting part on the recliner plate in the shape of a truncated cone. During assembly, this part penetrates an opening in the seat component and extends beyond the far side thereof. The diameter of the protruding portion is expanded, as a separate assembly step, so that it can no longer be removed. Welding around the near side of the opening-cone interface completes the assembly.

Frolo et al., in U.S. Pat. No. 6,505,889 issued Jan. 14, 2003 for “Automobile Vehicle Seat Including Hinge Mechanisms Connected in Rotation by a Connecting Bar” describes a seat having two hinges connected by a connecting bar which extends co-axially with or parallel to the pivot axis. The bar includes a series of flats in different angular planes to increase the bar flexibility which in turn reduces stress in the mechanism. This patent also relates to recliner vehicle seats.

A number of different patents have been identified which use a combination of attachment techniques, some including mechanical as weld attachment the patents arising in a variety of end use applications different from vehicle seating. These include U.S. Pat. No. 2,148,427 (Howard et al.) Feb. 28, 1939; U.S. Pat. No. 2,209,572 (Lewis) Jul. 30, 1940; U.S. Pat. No. 2,957,237 (Regle et al.) Oct. 25, 1960, U.S. Pat. No. 2,979,806 (Macomber) Apr. 18, 1961; U.S. Pat. No. 2,995,806 (Allison et al.) Aug. 15, 1961; U.S. Pat. No. 3,914,861 (Phillips) Oct. 28, 1975; U.S. Pat. No. 4,065,846 (Leonard, Jr.) Jan. 3, 1978; U.S. Pat. No. 5,522,536 (Kallenberger) Jun. 4, 1996; and U.S. Pat. No. 5,749,670 (Astor) May 12, 1998.

While a variety of processes and devices are known in various fields which vehicles to employ two or more attachment techniques, a significant advance in the vehicle seating art would occur if a highly effective, easy-to-assemble, lightweight system could be developed for coupling recliner components to side members of vehicle seats. Such a system would preferably eliminate the need for threaded fasteners or any additional assembly steps, such as the flaring step in the above-referenced Thieme '196 patent.

### FEATURES AND SUMMARY OF THE INVENTION

A primary feature of the present invention is to provide a mechanically locked recliner which is easy to assemble, which provides improved reliability in an impact or impulse situation, and which may in some instances reduce the overall weight of the seat system.

A different feature of the present invention is to provide a mechanically locked recliner system which is readily adaptable to a variety of vehicle seating designs, sizes and types.

Another feature of the present invention is to provide a mechanically locked recliner system which may further include rivet or weld fastening of the recliner part to the seat part for fit-up, BSR (buzz, squeak, rattle) prevention or for other purposes.

A still further feature of the present invention is to provide a mechanically locked recliner system which meets strength requirements even where weld penetration may not be sufficient.

Yet a further feature of the present invention is to provide a mechanically locked recliner system in which a minor amount of movement can occur in an impact or impulse situation, which movement is then stopped by the mechanical locking design.

How the foregoing and other features of the present invention are accomplished individually, collectively or in any sub-combination, will be described in the following detailed description of the preferred and illustrated embodiment of a mechanically locked recliner, taken in conjunction with the FIGURES. Generally, however, they are accomplished by providing a cavity in a component of the seat frame and by providing a complementary portion on a recliner component, e.g., a recliner plate, adapted to fit within the cavity, preferably to slide into a channel in a close tolerance, but not necessarily an interference fit. The recliner part fits far enough into the seat cavity that the required strength of the combination is achieved. If desired for welding fit-up and/or to prevent BSR issues, the two components can be joined by parent metal riveting, welding or the like. In the event of a force being applied to the mechanically locked recliner and seat components, if any rivets or welds can fail, only small movement will occur until the two components engage one another and prevent further movement. In the illustrated and preferred embodiment, the channel is generally C-shaped and has a major dimension lying in a plane in the direction of travel of the vehicle and perpendicular to the front and rear edges of the vehicle seat cushion. The recliner includes a plate adapted to slide into a channel. Other ways in which the above-referenced and additional features of the present invention are accomplished will become apparent to those skilled in the art after they have read the remainder of this specification. Such other ways are deemed to fall within the scope of the present invention if they fall within the scope of the claims which follow.

There is also provided a vehicle seat including a seat cushion and a seat back with a mechanically locked seat recliner system. The seat recliner comprises a seating component coupled to the seat back. A recliner component is coupled to the seat cushion. One of the components has a cavity to receive at least a portion of the other component. The portion of the other component is configured to fit entirely within the cavity. The cavity and the portion are configured to permit limited movement with respect to each other when the portion is placed in the cavity and to constrain further movement during one of an impact and impulse event.

### BRIEF DESCRIPTION OF THE DRAWINGS

In the various FIGURES like reference numerals will be used to identify like components, and,

FIG. 1 is a perspective view of the front of a combined recliner plate and seat frame component according to the preferred embodiment of a mechanically locked recliner;

FIG. 2 is a rear perspective view of the combination shown in FIG. 1;

FIG. 3 is a schematic sectional view through a plate and channel combination and illustrating the close size relationships and fit-up welding used in the preferred embodiment of the mechanically locked recliner; and

FIG. 4 is a schematic diagram illustrating how an exemplary embodiment of a mechanically locked recliner prevents large movement upon an impact or impulse event.

FIG. 5 is a side view of an exemplary embodiment of a vehicle seat including a mechanically locked recliner system.

### DETAILED DESCRIPTION OF THE PREFERRED AND ALTERNATE EMBODIMENTS OF THE INVENTION

Before beginning the description of the preferred and alternate embodiments of the present invention, several general comments can be made about the applicability and scope thereof.

First, while automotive seating will be referred to in the following portions of the specification, the invention is useful in all types of vehicle seating including, but not limited to, cars, SUVs, vans, trucks, buses and the like, where it is desirable to prevent one seating component from being significantly displaced with respect to another under an impact or impulse force.

Second, the following discussion and illustrations generally are directed to a side channel member of a seat frame and a recliner plate component of a seat back recliner. However, depending on the construction of the seat and the recliner mechanism, other parts can be mechanically locked according to the scope and teachings of this specification. Furthermore, the components can be reversed, i.e., the recliner plate could be C-shaped and be adapted to slide over rather than sliding into the seat frame member.

Third, with regard to the materials for the construction of the mechanically locked components, materials currently in use are entirely appropriate, as well as others selected by those skilled in the specification of materials for use in vehicle seating. Strength, welding capabilities and fabrication adaptability would be factors considered by one skilled in this art seeking to adapt the teachings of the present invention to a particular recliner design.

Fourth, as discussed briefly above, it may be desirable (as shown in the illustrated embodiment) to weld the otherwise mechanically locked components to each other. Such bonding will eliminate BSR issues, as well as the need to precisely hold the relative position of the components for subsequent operations, such as trim-out and installation.

Fifth, the term mechanically locked is used in this specification to describe a relationship between two or more components, rather than to indicate that the components are physically constrained against any movement, one with respect to the other. Ease of assembly and the ability to reduce damage in the event of weld failures are both features of the invention, and both are accomplished in a highly desirable way by designing the components to be easily moved toward one another so that a “fit” is accomplished which allows, at most, a small amount of movement to occur between the parts in the event of an applied impact or impulse force. In fact, it is desirable in the most preferred embodiment that there be some movement possible between the components when one fits into the other. This is not a true interference fit as that term is commonly understood, but rather a placement of the components in a close fitting, but at least partially separated relationships. Portions of one component may contact the other component, but it is not necessary or particularly desirable for adjacent portions to be in contact at all locations. Not only would manufacturing tolerances need to be very precise (and expensive) for that to occur, slight movement may actually aid assembly, especially if welding is employed. The movement may allow alignment and proper fit-up welding.

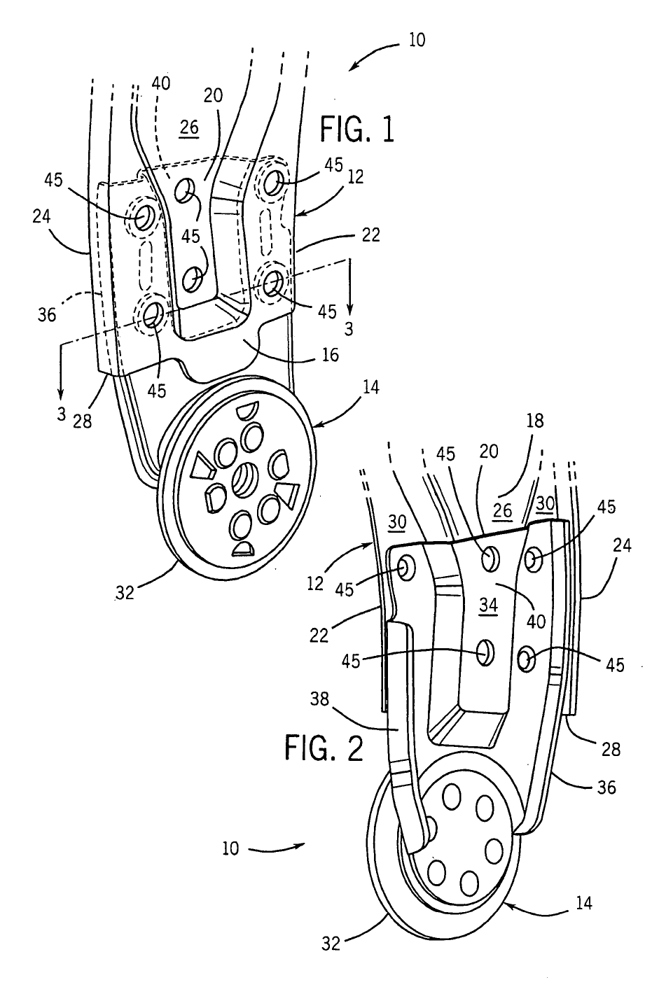

With regard to the profiles of the two mechanically locked components, FIGS. 1 and 2 below illustrate a completed embodiment, but the cross-sectioned profiles of the components are somewhat complex, making any full understanding of the invention more difficult for those who only look at the FIGURES.

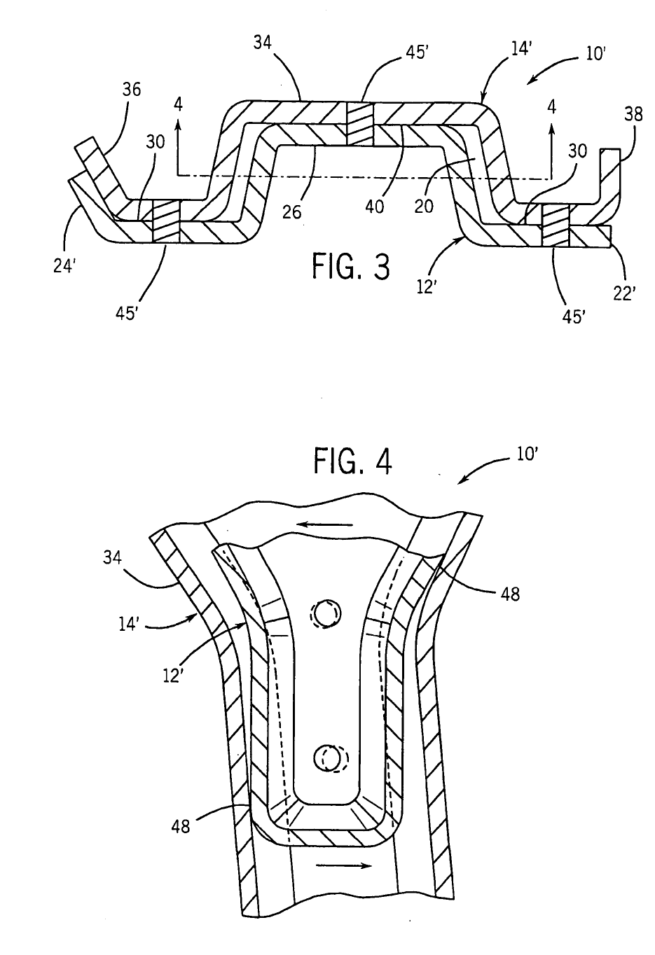

FIG. 3, on the other hand, is a very simplified view and is for purposes of illustration and understanding. The latter are not to scale, and the relative dimensions of the illustrated recliner plate and the seating component show gaps and weld thicknesses which are larger than those which would exist in a commercial vehicle mechanically locked system.

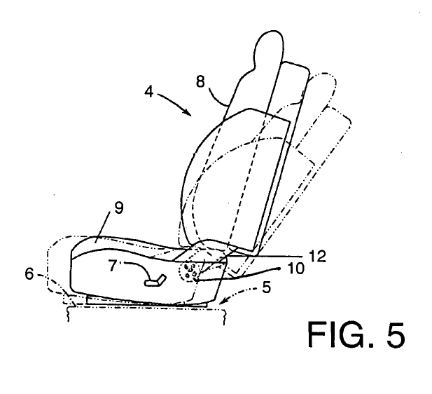

FIG. 4 shows only two square boxes, but it illustrates very well the basic principle of operation of the present invention, the possibility of a small amount of movement between the two components in the event of a weld failure, which movement is then stopped and constrained, not by a fastening process, but by the design of the components themselves.

FIG. 5 illustrates a vehicle seat 4 including a seat cushion 9 coupled to a seat back 8 with an exemplary embodiment of a mechanically locked recliner system 10. The vehicle seat 4 may include a seat control 7 to adjust the seat in several configurations. The seat control 7 may be manually operated or coupled to an actuator, for example, an electric motor. The vehicle seat 4 is coupled to a vehicle floor system 5 and includes a seat support 6, for example a rail system or a pedestal.

Referring now to FIGS. 1 and 2, a mechanically locked vehicle seat recliner system 10 is shown to include a seat back frame element 12 and a recliner plate element 14. The former includes a front 16 (see FIG. 1) and a back 18 (see FIG. 2) which define a cavity 20 there between. In the illustrated recliner system 10, front surface 16 includes a front edge 22, a rear edge 24 and an elongated rib 26 which extends from an upper portion (not shown) of back frame element 12 toward but not reaching the lower open end 28 thereof. Rib 26 creates a pair of channels 30 on either side which extend from front surface 16 to back surface 18. In the illustrated embodiment of FIGS. 1 and 2, the back 18 is defined by generally coplanar, spaced-apart flanges which are parallel to and spaced apart from the front 16 (see FIG. 3 for a simplified drawing of the system).

Seat back member 12 is preferably made of sheet metal, but it could be made of other materials, such as plastics. Also in the illustrated design, all components of the seat back frame element 12 are integral (made from a single piece of material) but unitary construction is not required for application of the principles of the recliner system 10.

The recliner plate element 14 of the illustrated embodiment includes a circular recliner disk 32. As is well-known, recliners generally include a first component coupled to a seat back 8 and a second component (not shown) coupled to the seat cushion frame 9, seat support 6, floor system 5 or other vehicle component. The two components (and other associated components) are adapted to cause the manual or powered movement of the seat back relative to the seat cushion of the vehicle seat. For purposes of explaining an exemplary embodiment of a mechanically locked recliner system 10, we have chosen to illustrate the circular disk 32 as the component coupled to the seat back (through seat back frame element 12), but it should be clearly understood that the particular component shown is for description purposes only, and that the design of the recliner component coupled to frame element 12 and the recliner mechanism can be varied widely.

To properly position disk 32 relative to seat back frame element 12, disk 32 is formed as part of plate element 14. Element 14 includes a plate 34 adapted to slide into the cavity 20 of seat back frame element 12. In this regard, plate 34 includes front and rear, generally U-shaped edges, 36 and 38, respectively, and a central, larger U-shaped portion 40. Front and rear edges 36 and 38 slide into channels 30, while portion 40 is adapted to slide over rib 26.

The clearances between elements 12 and 14 should be sufficient to permit manual or robotic assembly, but as explained above and illustrated below, they do not need to be precise. In the recliner design shown in FIGS. 1 and 2, such sliding assembly is facilitated by the lower end of rib 26 and the complimentary portion 40 on the recliner plate 34, i.e., element 14 is inserted into the cavity 20 of element 12 until further insertion is halted by contact between these two complementary features.

The illustrated embodiment of FIGS. 1 and 2 also includes six welds 45 to securely lock elements 12 and 14 together. While such welds are desirable to reduce BSR and to locate the two components in a precise spatial relationship, the welds do not need to be as numerous or as strong as would be required if the mechanical locking benefits of the present invention were not present. In fact, failure of some or all of the welds 45 during an impact or impulse event would result in minimal movement of the two components with respect to each other. The profiles of the components illustrated do an excellent job of preventing such movement.

To explain the operation of an exemplary embodiment of a recliner system 10, two schematic illustrations will be presented as FIGS. 3 and 4. To assist in the explanation, reference numerals with prime (′) signs will be used to show parts which are shown also in FIGS. 1 and 2, although it will be clear that FIGS. 3 and 4 are greatly simplified and do not show the profile characteristics of the first two FIGURES, the rib 26, the edges 36, 38 and portion 40, among other features. Rather FIG. 3 merely shows how a rib 26 is received within a cavity of frame element 14′ and is welded thereto at 45′.

FIG. 4 shows what would happen in the event a front impact or impulse force were imposed on the system 10, 10′ of the present invention with weld failure. The plate 34, 34′ would move a very small distance and then contact the frame element 12, 12′ as shown at reference numeral 48. At this point, further movement is prevented by the mechanical lock feature of the recliner system 10.

While exemplary embodiments of a mechanically locked recliner has been shown and described schematically and by reference to a preferred design, the scope is not to be limited thereby but is to be limited solely by the scope of the claims which follow. For example, while the illustrated and described embodiments refer to sliding one component into the other, the two components could be snapped or rotated into a position where a mechanical locking would occur during an impact or impulse event.

1. A mechanically locked vehicle seat recliner system comprising:
a seating component;
a recliner component;
one of the components having a cavity to receive at least a portion of the other component, the portion of the other component being entirely within the cavity; and
the cavity and the portion being configured to permit limited movement with respect to each other when the portion is placed in the cavity and to constrain further movement during one of an impact and impulse event.

2. The seat recliner system of claim 1, wherein the portion of the other component is configured to slide into the cavity of the one component.

3. The seat recliner system of claim 1 wherein the seating component is a backrest side element having a cavity, and the recliner component is a recliner plate having a plate portion.

4. The seat recliner system of claim 1 wherein the seating component and the recliner portion are welded to each other after the portion is placed in the cavity.

5. The seat recliner system of claim 1 wherein the seating component has an interior profile and the recliner component has a portion having a profile which permits sliding movement between the two components.

6. A method for locking a vehicle seat recliner, with the vehicle seat having a reclining back and a seat, the method comprising the steps of:
providing a seating component coupled to the seat;
providing a recliner component coupled to the reclining back;
configuring one of the components to have a cavity to receive at least a portion of the other component, the portion of the other component being entirely within the cavity; and
configuring the cavity and portion to permit limited movement with respect to each other when the portion is placed in the cavity and to constrain further movement during one of an impact and impulse event.

7. The method of claim 6, including the step of welding the seating component and the recliner component to each other after the portion is placed in the cavity.

8. The method of claim 6, including the steps of configuring the seating component with an interior profile and configuring the portion to a profile which permits sliding movement between the seating component and recliner component.

9. The method of claim 6, wherein the seating component is a backrest side element having a cavity, and the recliner component is a recliner plate having a plate portion.

10. A vehicle seat comprising:
a seat cushion;
a seat back; and
a mechanically locked seat recliner system, the seat recliner comprising:
a seating component coupled to the seat back;
a recliner component coupled to the seat cushion;
one of the components having a cavity to receive at least a portion of the other component, the portion of the other component being entirely within the cavity; and
the cavity and the portion being configured to permit limited movement with respect to each other when the portion is placed in the cavity and to constrain further movement during one of an impact and impulse event.

11. The vehicle seat of claim 10, wherein the portion of the other component is configured to slide into the cavity of the one component.

12. The vehicle seat of claim 10 wherein the seating component is a backrest side element having a cavity, and the recliner component is a recliner plate having a plate portion.

13. The vehicle seat of claim 10 wherein the seating component and the recliner portion are welded to each other after the portion is placed in the cavity.

14. The vehicle seat of claim 10 wherein the seating component has an interior profile and the recliner component has a portion having a profile which permits sliding movement between the two components.
